(19) United States
(12) Patent Application Publication
(10) Pub. No.: US 2019/0165561 A1
(43) Pub. Date: May 30, 2019

(54) POWER SUPPLY CONTROL APPARATUS, POWER SUPPLY CONTROL METHOD, AND COMPUTER PROGRAM

(71) Applicants: AutoNetworks Technologies, Ltd., Yokkaichi (JP); Sumitomo Wiring Systems, Ltd., Yokkaichi (JP); Sumitomo Electric Industries, Ltd., Osaka (JP)

(72) Inventors: Shunichi SAWANO, Yokkaichi (JP); Yuuki SUGISAWA, Yokkaichi (JP)

(21) Appl. No.: 16/197,860

(22) Filed: Nov. 21, 2018

(30) Foreign Application Priority Data
Nov. 24, 2017 (JP) 2017-226161

(51) Int. Cl. H02H 3/027; H01H 47/00; H02H 3/38

(52) U.S. Cl. CPC H02H 3/027; H02H 3/38; H01H 47/00

(57) ABSTRACT

Provided is a power supply control apparatus, a power supply control method, and a computer program that can prevent an extremely large current from flowing via a switch. A power supply control apparatus is configured to control power supply via a switch. A control unit is configured to determine whether to switch ON a semiconductor switch. If the control unit determines to switch ON the switch, when a voltage value at a current input terminal of the switch, to which a current is input, is lower than a predetermined voltage value, a driving circuit is configured to switch ON the switch.

### CROSS-REFERENCE TO RELATED APPLICATIONS

This application claims priority of Japanese Patent Application No. JP 2017-226161 filed Nov. 24, 2017.

### TECHNICAL FIELD

The present disclosure relates to a power supply control apparatus, a power supply control method, and a computer program.

### BACKGROUND

A vehicle may be provided with a power supply control apparatus for controlling power supply via a switch. Specifically, a battery, a generator, and the like are connected to one end of the switch, and a load is connected to the other end of the switch. If the switch is switched ON, power is supplied to the load via the switch. If the switch is switched OFF, the power supply to the load is stopped.

The load is, for example, an electrical device that is installed in the vehicle. If an overvoltage is applied to the load for a long time period, the load may become defective. Accordingly, it is necessary to prevent an overvoltage from being applied to the load for a long time period.

JP 2006-50788A discloses a configuration for preventing an overvoltage from being applied to a load for a long time period via a switch. In this configuration, a switch is connected between a first terminal and a second terminal, a positive electrode of a battery is connected to the first terminal, and the load is connected to the second terminal. In the configuration disclosed in JP 2006-50788A, the switch is ON while the voltage at the first terminal is lower than a certain voltage, and power is supplied to the load via the switch. If the voltage at the first terminal is larger than or equal to the certain voltage, the switch is switched OFF, and the power supply to the load via the switch is stopped. In this manner, applying an overvoltage to the load for a long time period is prevented.

### SUMMARY

Let us assume that an overvoltage is generated, and both ends of the load are shorted-circuited in the above-mentioned power supply control apparatus. If the switch is switched from OFF to ON in this state, an extremely large current flows via the switch. In this case, the temperature of the lead wire that is connected to the switch rapidly increases, and there is a possibility that the function of the lead wire greatly deteriorates.

The present disclosure has been made in view of such circumstances, and it is an object thereof to provide a power supply control apparatus, a power supply control method, and a computer program that can prevent an extremely large current from flowing via a switch.

A power supply control apparatus according to one aspect of the present disclosure is a power supply control apparatus for controlling power supply via a switch, the apparatus includes: a determination unit configured to determine whether to switch ON the switch; and a switching unit configured to switch ON the switch, if the determination unit determines to switch ON the switch, and a voltage value at a current input terminal of the switch, to which a current is input, is lower than a predetermined voltage value.

A power supply control method according to one aspect of the present disclosure is a power supply control method for controlling power supply via a switch, the method including: a step of determining whether to switch ON the switch; and a step of switching ON the switch, if it is determined to switch ON the switch, and a voltage value at a current input terminal of the switch, to which a current is input, is lower than a predetermined voltage value.

A computer program according to one aspect of the present disclosure is a computer program for causing a computer to execute: a step of determining whether to switch ON a switch; a step of determining whether a voltage value at a current input terminal of the switch, to which a current is input, is lower than a predetermined voltage value, if it is determined to switch ON the switch; and a step of instructing to switch ON the switch, if it is determined that the voltage value at the current input terminal is lower than the predetermined voltage value.

Note, that the present disclosure can be realized as not only a power supply control apparatus including such characteristic processing units, but also a power supply control method including such characteristic processes as steps or a computer program for causing a computer to execute these steps. Also, the present disclosure can be realized as a semiconductor integrated circuit for realizing part or all of the power supply control apparatus, or as a power supply control system including the power supply control apparatus.

According to the above-mentioned aspect, it is possible to prevent an extremely large current from flowing via the switch.

### BRIEF DESCRIPTION OF THE DRAWINGS

FIG. 1 is a block diagram showing the configuration of the main portions of a power supply system in a first embodiment.

FIG. 2 is a flowchart showing a procedure of power supply start processing.

FIG. 3 is a flowchart showing a procedure of overvoltage prevention processing.

FIG. 4 is a flowchart showing a procedure of overcurrent prevention processing.

FIG. 5 is a flowchart showing a procedure of power supply stop processing.

FIG. 6 is a timing chart showing an operation of a power supply control apparatus.

FIG. 7 is a timing chart showing another operation of the power supply control apparatus.

FIG. 8 is a flowchart showing a procedure of power supply start processing in a second embodiment.

FIG. 9 is a flowchart showing a procedure of overvoltage prevention processing.

FIG. 10 is a timing chart showing an operation of the power supply control apparatus.

### DETAILED DESCRIPTION OF PREFERRED EMBODIMENTS

First, aspects of the present disclosure will be listed and described. At least some of the following aspects may be combined in any manner.

A power supply control apparatus according to one aspect of the present disclosure is a power supply control apparatus for controlling power supply via a switch, the apparatus includes: a determination unit configured to determine whether to switch ON the switch; a switching unit configured to switch ON the switch, if the determination unit determines to switch ON the switch, and a voltage value at a current input terminal of the switch, to which a current is input, is lower than a predetermined voltage value.

In the power supply control apparatus according to one aspect of the present disclosure, wherein the switching unit switches OFF the switch, if the switch is ON, and a state in which the voltage value at the current input terminal is larger than or equal to a second predetermined voltage value has continued for a predetermined time period.

In the power supply control apparatus according to one aspect of the present disclosure, wherein the switching unit switches OFF the switch, if the switch is ON, and a state in which a current value of a current that flows via the switch is larger than or equal to a predetermined current value has continued for a second predetermined time period.

A power supply control method according to one aspect of the present disclosure is a power supply control method for controlling power supply via a switch, the method including: a step of determining whether to switch ON the switch; and a step of switching ON the switch, if it is determined to switch ON the switch, and a voltage value at a current input terminal of the switch, to which a current is input, is lower than a predetermined voltage value.

A computer program according to one aspect of the present disclosure is a computer program for causing a computer to execute: a step of determining whether to switch ON a switch; a step of determining whether a voltage value at a current input terminal of the switch, to which a current is input, is lower than a predetermined voltage value, if it is determined to switch ON the switch; and a step of instructing to switch ON the switch, if it is determined that the voltage value at the current input terminal is lower than the predetermined voltage value.

In the power supply control apparatus, the power supply control method, and the computer program according to the above-mentioned aspect, if it is determined to switch ON the switch, and the voltage at the current input terminal is lower than the predetermined voltage, that is, when no overvoltage generates, the switch is switched ON. For this reason, an extremely large current is prevented from flowing via the switch.

In the power supply control apparatus according to the above-mentioned aspect, if a state in which a voltage at the current input terminal of the switch is large has continued for a long time period, the switch is switched OFF, and thus no overvoltage is output for a long time period via the switch. Also, because the switch is switched ON in a state where no overvoltage is generated, there is no possibility that an extremely large current flows for a predetermined time period via the switch.

In the power supply control apparatus according to the above-mentioned aspect, if a large current flows for a long time period via the switch, the switch is switched OFF, and thus no overcurrent flows for a long time period via the switch. Also, because the switch is switched ON in a state where no overvoltage is generated, there is no possibility that an extremely large current flows for a second predetermined time period via the switch.

A specific example of a power supply system according to embodiments of the present disclosure will be described below with reference to the drawings. Note, that the present disclosure is not limited to these examples but is defined by the claims, and is intended to encompass all modifications made within the meaning and scope equivalent to the claims.

### First Embodiment

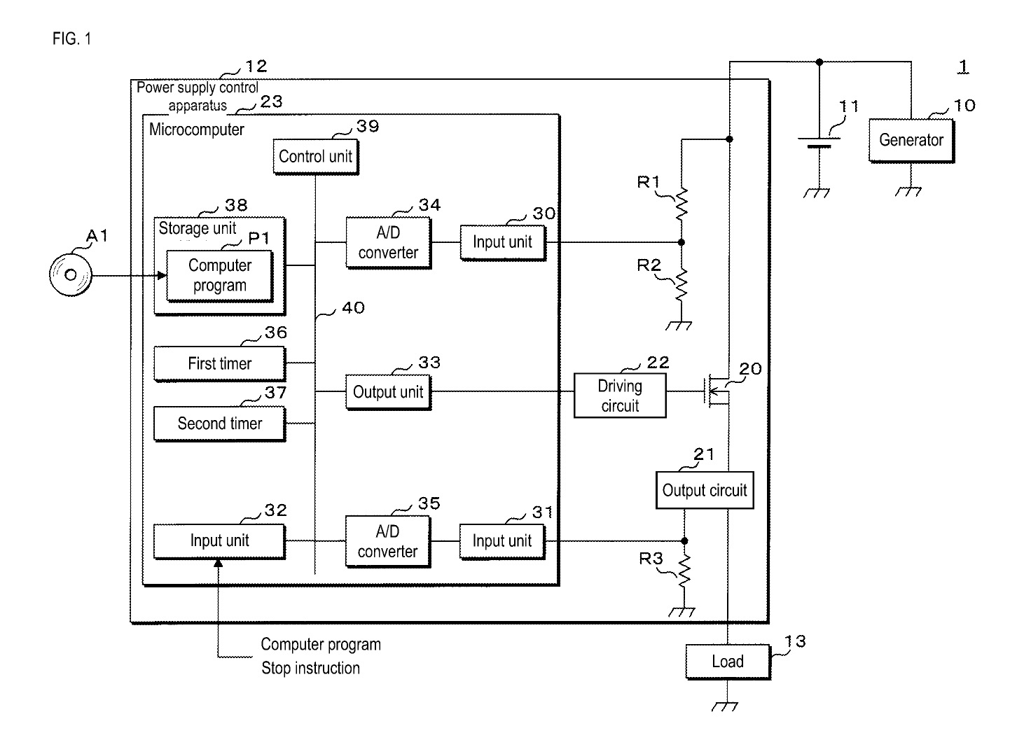

FIG. 1 is a block diagram showing the configuration of the main portions of a power supply system in a first embodiment. The power supply system 1 is preferably installed in a vehicle, and includes a generator 10, a battery 11, a power supply control apparatus 12, and a load 13. One end of the generator 10 is connected to the positive electrode of the battery 11 and the power supply control apparatus 12. The power supply control apparatus 12 is further connected to one end of the load 13. The ends of the other side of the generator 10 and the load 13, and the negative electrode of the battery 11 are grounded. The load 13 is an electric device that is installed in the vehicle.

If the generator 10 operates, the generator 10 generates AC power in conjunction with a not-shown engine, rectifies the generated AC power to DC power, and supplies the rectified power to the battery 11 and the load 13. The battery 11 is charged, by the generator 10 supplying power to the battery 11. Also, the generator 10 supplies power to the load 13 via the power supply control apparatus 12. If the generator 10 stops operating, the battery 11 supplies power to the load 13 via the power supply control apparatus 12.

The power supply control apparatus 12 controls power supply from the generator 10 or the battery 11 to the load 13. The power supply control apparatus 12 electrically connects the one end of the generator 10 and the one end of the load 13. In this manner, power is supplied from the generator 10 or the battery 11 to the load 13, and the load 13 operates. The power supply control apparatus 12 shuts off the electrical connection between the one end of the generator 10 and the one end of the load 13. In this manner, the power supply from the generator 10 or the battery 11 to the load 13 is stopped, and the load 13 stops operating.

The power supply control apparatus 12 has a semiconductor switch 20, an output circuit 21, a driving circuit 22, a microcomputer 23, and resistors R1, R2, and R3. The semiconductor switch 20 is an N-channel FET (Field Effect Transistor). The microcomputer 23 has input units 30, 31, and 32, an output unit 33, A(Analog)/D(Digital) converters 34 and 35, a first timer 36, a second timer 37, a storage unit 38, and a control unit 39.

The drain of the semiconductor switch 20 is connected to the one end of the generator 10 and the positive electrode of the battery 11. The source of the semiconductor switch 20 is connected to the output circuit 21. The output circuit 21 is further connected to the one end of the load 13.

The drain of the semiconductor switch 20 is further connected to one end of the resistor R1. The other end of the resistor R1 is connected to one end of the resistor R2. The other end of the resistor R2 is grounded. A connection node between the resistors R1 and R2 is connected to the input unit 30 of the microcomputer 23, and the input unit 30 is further connected to the A/D converter 34. The gate of the semiconductor switch 20 is connected to the driving circuit 22, and the driving circuit 22 is also connected to the output unit 33 of the microcomputer 23.

The output circuit 21 is further connected to one end of the resistor R3, and the other end of the resistor R3 is grounded. A connection node between the output circuit 21 and the resistor R3 is connected to the input unit 31 of the microcomputer 23. The input unit 31 is further connected to the A/D converter 35. The input unit 32, the output unit 33, the A/D converters 34 and 35, the first timer 36, the second timer 37, the storage unit 38, and the control unit 39 are connected to a bus 40.

If the gate voltage of the semiconductor switch 20 with respect to the source potential is larger than or equal to a predetermined voltage, a current can flow through the drain and source. At this time, the semiconductor switch 20 is ON. If the gate voltage of the semiconductor switch 20 with respect to the source potential is lower than the predetermined voltage, no current flows through the drain and source. At this time, the semiconductor switch 20 is OFF.

The output unit 33 of the microcomputer 23 outputs a high level voltage or a low level voltage to the driving circuit 22. The output unit 33 switches a voltage that is output to the driving circuit 22 to a high level voltage or a low level voltage, in accordance with an instruction from the control unit 39.

If the voltage that the output unit 33 outputs is switched from a low level voltage to a high level voltage, the driving circuit 22 increases the gate voltage of the semiconductor switch 20 with respect to the ground potential. As a result, the gate voltage with respect to the source potential is larger than or equal to a certain voltage, and the semiconductor switch 20 is switched ON.

If the voltage that the output unit 33 outputs is switched from a high level voltage to a low level voltage, the driving circuit 22 decreases the gate voltage of the semiconductor switch 20 with respect to the ground potential. As a result, the gate voltage with respect to the source potential is lower than the certain voltage, and the semiconductor switch 20 is switched OFF. The driving circuit 22 serves as a switching unit.

If the driving circuit 22 switches ON the semiconductor switch 20, the ends on one side of the generator 10 and the load 13 are electrically connected. Accordingly, a current flows from a generator 10 or the battery 11 to the load 13 via the semiconductor switch 20 and the output circuit 21. As a result, power is supplied to the load 13, and the load 13 operates. A current flows through the drain and source of the semiconductor switch 20 in this order. The drain of the semiconductor switch 20 serves as a current input terminal to which a current is input.

If the driving circuit 22 switches OFF the semiconductor switch 20, the electrical connection between the ends on one side of the generator 10 and the load 13 is shut off. Accordingly, the current that flows via the semiconductor switch 20 is shut off, and the power supply to the load 13 is stopped. As a result, the load 13 stops operating.

As mentioned above, in the power supply control apparatus 12, power supply via the semiconductor switch 20 is controlled, by the driving circuit 22 switching ON or OFF the semiconductor switch 20.

The resistors R1 and R2 divide the drain voltage of the semiconductor switch 20. The voltage value of the voltage that is divided by the resistors R1 and R2 is output from the connection node between the resistors R1 and R2 to the input unit 30 of the microcomputer 23, as analog voltage value information that indicates the drain voltage value of the semiconductor switch 20 (hereinafter, referred to as “input voltage value”). The voltage value information, that is, the voltage value of the voltage divided by the resistors R1 and R2 is K times the input voltage value (K is a positive real number less than 1). The real number K is a constant value, and is 0.1, for example. The input voltage value is expressed as “input voltage value information”/K.

The input unit 30 outputs the input analog voltage value information to the A/D converter 34. The A/D converter 34 converts the analog voltage value information that is input from the input unit 30 to digital voltage value information. The control unit 39 acquires the digital voltage value information from the A/D converter 34. The input voltage value of the voltage value information acquired by the control unit 39 substantially coincides with the input voltage value at the time of acquisition.

As mentioned above, a current flows to the load 13 via the semiconductor switch 20 and the output circuit 21. The output circuit 21 outputs a current, which depends on the current value of the current flowing through the load 13 via the semiconductor switch 20 (hereinafter, referred to as “switch current value”), to the resistor R3. The output current flows through the resistor R3. The current value of the current that the output circuit 21 outputs to the resistor R3 is M times the switch current value (M is a positive real number less than 1). The real number M is, for example, 0.001. If the resistance value of the resistor R3 is expressed as r3, the voltage across the resistor R3 is expressed as r3·M·“switch current value”. The symbol “·” expresses the multiplication.

The real number M and the resistance value r3 are constant values. Accordingly, the voltage value across the resistor R3 indicates the switch current value. The voltage value across the resistor R3 is output to the input unit 31 of the microcomputer 23, as analog current value information that indicates the switch current value. The switch current value is expressed as “current value information”/(r3·M).

The input unit 31 outputs the input analog current value information to the A/D converter 35. The A/D converter 35 converts the analog current value information that is input from the input unit 31 to digital current value information. The control unit 39 acquires the digital current value information from the A/D converter 35. The switch current value of the current value information that is acquired by the control unit 39 substantially coincides with the switch current value at the time of acquisition.

The input unit 32 receives an operation instruction that instructs the operation of the load 13, and a stop instruction that instructs the stop of the operation of the load 13. If the input unit 32 receives an operation instruction or a stop instruction, the input unit 32 notifies the control unit 39 of the input instruction.

Each of the first timer 36 and the second timer 37 starts and stops time counting, in accordance with an instruction from the control unit 39. The control unit 39 reads out the counted time period that the first timer 36 has counted from the first timer 36, and reads out the counted time period that the second timer 37 has counted from the second timer 37.

The storage unit 38 is a non-volatile memory. The storage unit 38 stores a computer program P1. The control unit 39 has a not-shown CPU (Central Processing Unit). By executing the computer program P1, the CPU of the control unit 39 executes power supply start processing, overvoltage prevention processing, overcurrent prevention processing, and power supply stop processing.

The power supply start processing is processing for starting power supply to the load 13. The overvoltage prevention processing is processing for preventing an overvoltage from being applied to the load 13 for a long time period. The overcurrent prevention processing is processing for preventing an overcurrent from flowing to the load 13 for a long time period. The power supply stop processing is processing for stopping power supply to the load 13.

The computer program P1 is used for causing the CPU of the control unit 39 to execute the power supply start processing, the overvoltage prevention processing, the overcurrent prevention processing, and the power supply stop processing.

Note, that the computer program P1 may also be stored in a storage medium A1 to be readable by the CPU of the control unit 39. In this case, the computer program P1, which is read out from the storage medium A1 by a not-shown readout apparatus, is stored in the storage unit 38. The storage medium A1 is an optical disk, a flexible disk, a magnetic disk, a magneto-optical disk, a semiconductor memory, or the like. The optical disk is a CD (Compact Disc)-ROM (Read Only Memory), a DVD (Digital Versatile Disc)-ROM, a BD (Blu-ray (registered trademark) Disc), or the like. The magnetic disk is a hard disk, for example. Also, the computer program P1 may be downloaded from a not-shown external apparatus that is connected to a not-shown communication network, and the downloaded computer program P1 may also be stored in the storage unit 38.

If the generator 10 generates power and charges the battery 11, for example, and then the positive electrode of the battery 11 is opened, that is, when the power supply system 1 is in a load dump state, an overvoltage is generated at the one end of the generator 10. If both ends of the load 13 are short-circuited in a state where the semiconductor switch 20 is ON, for example, an overcurrent is generated. An overvoltage and an overcurrent may also be generated by external disturbance noise.

The storage unit 38 further stores a flag value. The flag value is zero or 1. The fact that the flag value is zero means that the semiconductor switch 20 is OFF. The fact that the flag value is 1 means that the semiconductor switch 20 is ON. The flag value is changed by the control unit 39.

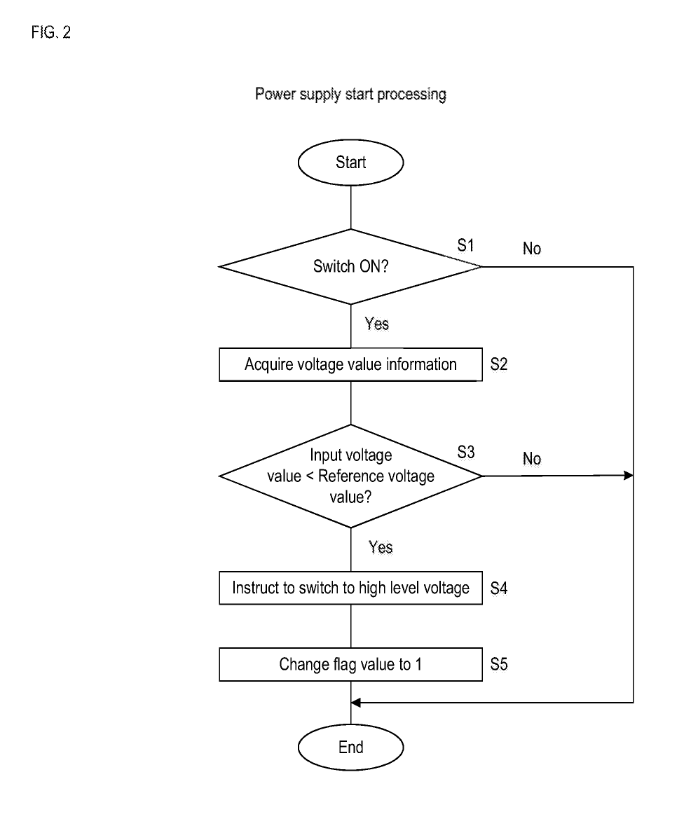

FIG. 2 is a flowchart showing a procedure of the power supply start processing. If the flag value is zero, that is, if the semiconductor switch 20 is OFF, the control unit 39 periodically executes the power supply start processing. First, the control unit 39 determines whether to switch ON the semiconductor switch 20 (step S1). Specifically, in step S1, the control unit 39 determines to switch ON the semiconductor switch 20 if the input unit 32 receives an operation instruction, and determines not to switch ON the semiconductor switch 20 if the input unit 32 receives no operation instruction. The control unit 39 serves as a determination unit.

If the control unit 39 determines to switch ON the semiconductor switch 20 (YES in S1), the control unit 39 acquires voltage value information from the A/D converter 34 (step S2). Then, the control unit 39 determines whether the input voltage value of the acquired voltage value information is lower than a reference voltage value (step S3). The reference voltage value is a constant value, and is predetermined. As mentioned above, the voltage value information is a voltage value that is expressed by K·“input voltage value”.

If the control unit 39 determines that the input voltage value is lower than the reference voltage value (YES in S3), the control unit 39 instructs the output unit 33 to switch to a high level voltage (step S4). In this manner, the output unit 33 switches the voltage that is output to the driving circuit 22 from a low level voltage to a high level voltage. As a result, the driving circuit 22 switches ON the semiconductor switch 20, and power supply from the generator 10 or the battery 11 to the load 13 is started.

Instructing the output unit 33 to switch to a high level voltage corresponds to instructing the driving circuit 22 to switch ON the semiconductor switch 20.

After it executes step S4, the control unit 39 changes the flag value to 1 (step S5). If the control unit 39 determines not to switch ON the semiconductor switch 20 (NO in S1), if the control unit 39 determines that the input voltage value is larger than or equal to the reference voltage value (NO in S3), or after the control unit 39 executes step S5, the control unit 39 ends the power supply start processing.

As mentioned above, in the power supply start processing, if the flag value is zero, that is, if the semiconductor switch 20 is OFF, the control unit 39 waits until the input unit 32 receives an operation instruction. As previously mentioned, if the input unit 32 receives an operation instruction, the control unit 39 determines to switch ON the semiconductor switch 20. If the control unit 39 determines to switch ON the semiconductor switch 20, and the input voltage value, that is, the drain voltage value of the semiconductor switch 20 is lower than the reference voltage value, the driving circuit 22 switches ON the semiconductor switch 20. In the same case, if the control unit 39 determines that the input voltage value is larger than or equal to the reference voltage value, the driving circuit 22 does not switch ON the semiconductor switch 20, and keeps the semiconductor switch 20 OFF.

Note, that if the flag value is 1, and the input unit 32 receives an operation instruction, the control unit 39 execute no processing, and the driving circuit 22 keeps the semiconductor switch 20 ON. Also, in step S3, if the control unit 39 determines that the input voltage value is larger than or equal to the reference voltage value, a not-shown output unit included in the microcomputer 23 may output a notification signal for notifying generation of an overvoltage.

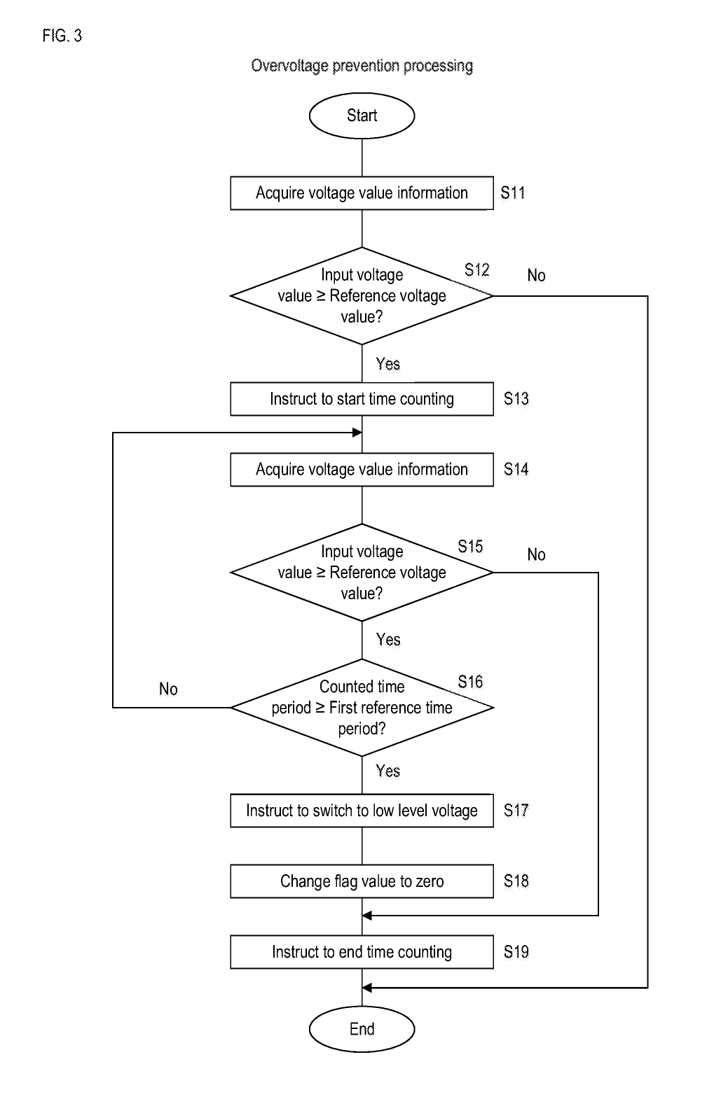

FIG. 3 is a flowchart showing a procedure of the overvoltage prevention processing. If the flag vale is 1, that is, if the semiconductor switch 20 is ON, the control unit 39 periodically executes the overvoltage prevention processing. First, the control unit 39 acquires voltage value information from the A/D converter 34 (step S11). Next, the control unit 39 determines whether the input voltage value of the voltage value information acquired in step S11 is larger than or equal to the reference voltage value (step S12).

If the control unit 39 determines that the input voltage value is larger than or equal to the reference voltage value (YES in S12), the control unit 39 instructs the first timer 36 to start time counting (step S13). In this manner, the first timer 36 starts counting time. Next, the control unit 39 acquires voltage value information from the A/D converter 34 again (step S14), and determines whether the input voltage value of the acquired voltage value information is larger than or equal to the reference voltage value (step S15).

If the control unit 39 determines that the input voltage value is larger than or equal to the reference voltage value (YES in S15), the control unit 39 determines whether the counted time period that is being counted by the first timer 36 is longer than or equal to a first reference time period (step S16). The first reference time period is a constant time period, and is predetermined. If the control unit 39 determines that the counted time period is shorter than the first reference time period (NO in S16), the control unit 39 executes step S14, and waits until the input voltage value is lower than the reference voltage value, or until the counted time period of the first timer 36 is longer than or equal to the first reference time period.

If the control unit 39 determines that the counted time period is longer than the first reference time period (YES in S16), the control unit 39 instructs the output unit 33 to switch to a low level voltage (step S17). In this manner, the output unit 33 switches the voltage that is output to the driving circuit 22 from a high level voltage to a low level voltage. As a result, the driving circuit 22 switches OFF the semiconductor switch 20, and power supply to the load 13 is stopped.

Instructing the output unit 33 to switch to a low level voltage corresponds to instructing the driving circuit 22 to switch OFF the semiconductor switch 20.

After it executes step S17, the control unit 39 changes the flag value to zero (step S18). If the control unit 39 determines that the input voltage value is lower than the reference voltage value (NO in S15), or after the control unit 39 executes step S18, the control unit 39 instructs the first timer 36 to end time counting (step S19). In this manner, the first timer 36 stops counting time. If the control unit 39 determines that the input voltage value is lower than the reference voltage value (NO in S12), or after the control unit 39 executes step S19, the control unit 39 ends the overvoltage prevention processing.

As mentioned above, if the flag value is 1, that is, if the semiconductor switch 20 is ON, and a state in which the input voltage value is larger than or equal to the reference voltage value has continued for the first reference time period, the driving circuit 22 switches OFF the semiconductor switch 20.

If an overvoltage is generated by the state of the power supply system 1 being in a load dump state, the time period, for which the state in which the input voltage value is larger than or equal to the reference voltage value has been continued, is several hundred ms, for example, and is long. If an overvoltage is generated due to external disturbance noise, the time period, for which the state in which the input voltage value is larger than or equal to the reference voltage value has been continued, is several tens of μs, for example, and is short. Accordingly, as one example, the first reference time period is set to several hundred μs. In this manner, if an overvoltage is generated due to external disturbance noise, the semiconductor switch 20 is kept ON. On the other hand, if an overvoltage is generated by the state of the power supply system 1 being in a load dump state, the semiconductor switch 20 is switched OFF.

Note, that in step S16, if the control unit 39 determines that the counted time period is longer than or equal to the first reference time period, the not-shown output unit included in the microcomputer 23 may output a notification signal for notifying that an overvoltage has been applied for a long time period.

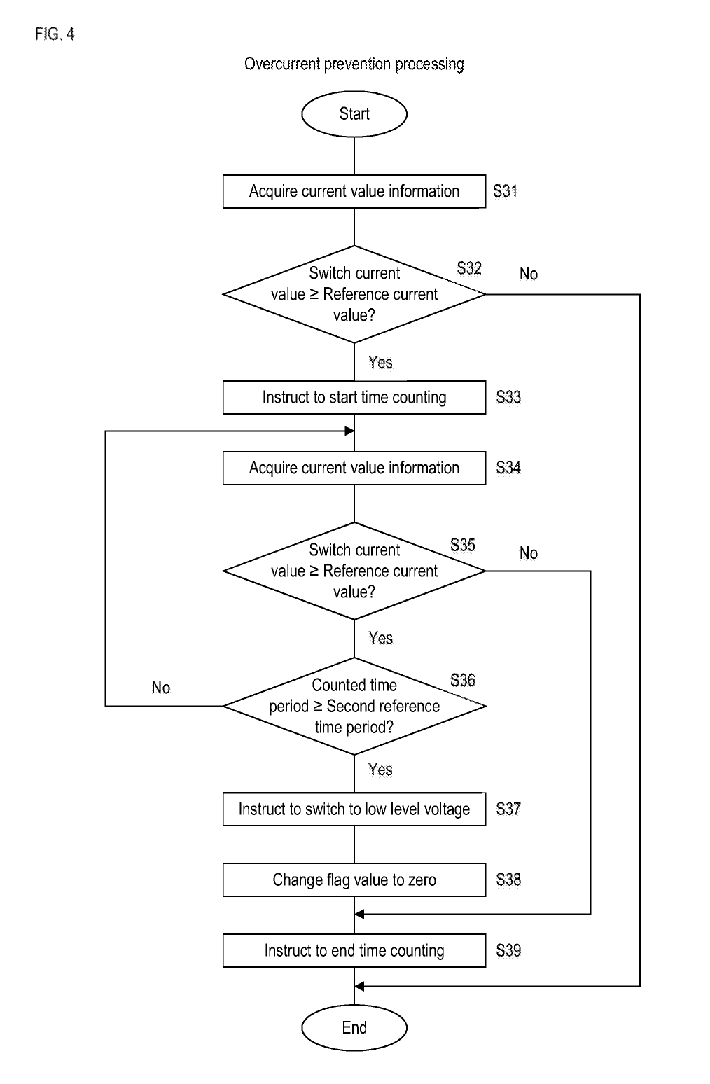

FIG. 4 is a flowchart showing a procedure of the overcurrent prevention processing. If the flag vale is 1, that is, if the semiconductor switch 20 is ON, the control unit 39 periodically executes the overcurrent prevention processing. If the flag vale is 1, the control unit 39 periodically executes the power supply stop processing. The control unit 39 executes the overvoltage prevention processing, the overcurrent prevention processing, and the power supply stop processing in a time-division manner. Accordingly, for example, the control unit 39 executes any other processing while waiting in one of the overvoltage prevention processing, the overcurrent prevention processing, and the power supply stop processing.

In the overcurrent prevention processing, first, the control unit 39 acquires current value information from the A/D converter 35 (step S31). Next, the control unit 39 determines whether the switch current value of the voltage value information acquired in step S31 is larger than or equal to the reference current value (step S32). As mentioned above, the current value information is a voltage value that is expressed as M·r3·“switch current value”. The reference current value is a constant value, and is predetermined.

If the control unit 39 determines that the switch current value is larger than or equal to the reference current value (YES is S32), the control unit 39 instructs the second timer 37 to start time counting (step S33). In this manner, the second timer 37 starts counting time. Next, the control unit 39 acquires current value information from the A/D converter 35 again (step S34), and determines whether the switch current value of the acquired current value information is larger than or equal to the reference current value (step S35).

If the control unit 39 determines that the switch current value is larger than or equal to the reference current value (YES is S35), the control unit 39 determines whether the counted time period that is being counted by the second timer 37 is longer than or equal to a second reference time period (step S36). The second reference time period is a constant time period, and is predetermined. If the control unit 39 determines that the counted time period is shorter than the second reference time period (NO in S36), the control unit 39 executes step S34, and waits until the switch current value is larger than or equal to the reference current value, or until the counted time period of the second timer 37 is longer than or equal to the second reference time period.

If the control unit 39 determines that the counted time period is longer than or equal to the second reference time period (YES in S36), the control unit 39 instructs the output unit 33 to switch to a low level voltage (step S37). In this manner, the output unit 33 switches the voltage that is output to the driving circuit 22 from a high level voltage to a low level voltage. As a result, the driving circuit 22 switches OFF the semiconductor switch 20, and power supply to the load 13 is stopped.

After it executes step S37, the control unit 39 changes the flag value to zero (step S38). If the control unit 39 determines that the switch current value is lower than the reference current value (NO in S35), or after the control unit 39 executes step S38, the control unit 39 instructs the second timer 37 to end time counting (step S39). In this manner, the second timer 37 stops counting time. If the control unit 39 determines that the switch current value is lower than the reference current value (NO in S32), or after the control unit 39 executes step S39, the control unit 39 ends the overcurrent prevention processing.

As mentioned above, if the flag value is 1, that is, if the semiconductor switch 20 is ON, and a state in which the switch current value is larger than or equal to the reference current value has continued for the second reference time period, the driving circuit 22 switches OFF the semiconductor switch 20.

Note, that in step S36, if the control unit 39 determines that the counted time period is longer than or equal to the second reference time period, the not-shown output unit included in the microcomputer 23 may output a notification signal for notifying that an overcurrent has flowed for a long time period.

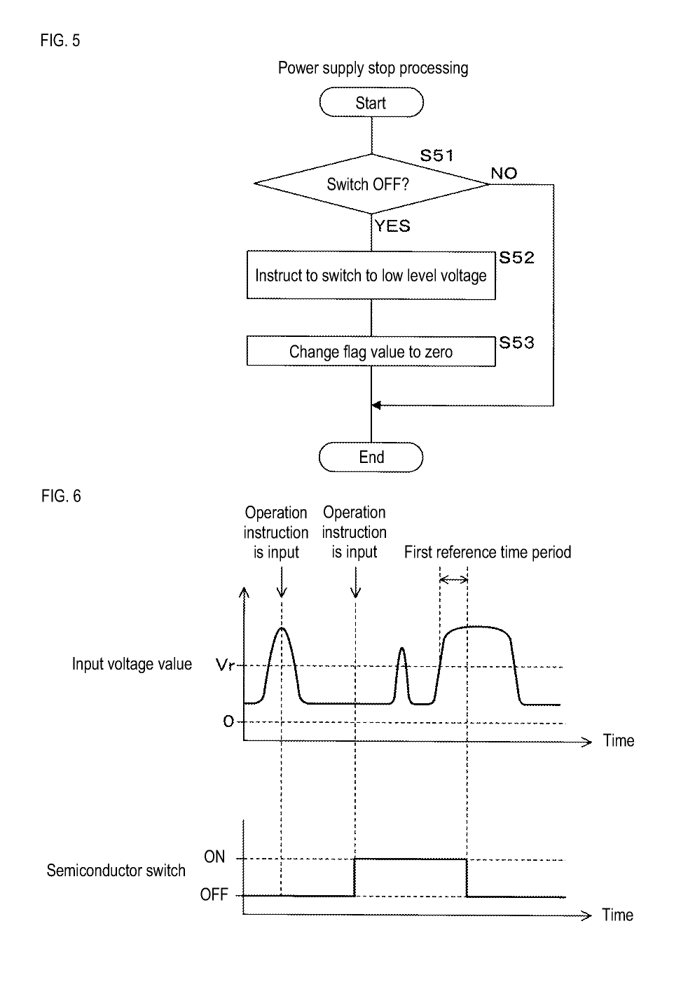

FIG. 5 is a flowchart showing a procedure of the power supply stop processing. As mentioned above, if the flag vale is 1, the control unit 39 periodically executes the power supply stop processing. First, the control unit 39 determines whether to switch OFF the semiconductor switch 20 (step S51). Specifically, in step S51, if the input unit 32 receives a stop instruction, the control unit 39 determines that semiconductor switch 20 is to be switched OFF.

On the other hand, if the input unit 32 receives no stop instruction, the control unit 39 determines that semiconductor switch 20 is not to be switched OFF.

If the control unit 39 determines to switch OFF the semiconductor switch 20 (YES in S51), the control unit 39 instructs the output unit 33 to switch to a low level voltage (step S52). In this manner, the output unit 33 switches the voltage that is output to the driving circuit 22 from a high level voltage to a low level voltage. As a result, the driving circuit 22 switches OFF the semiconductor switch 20, and power supply to the load 13 is stopped.

After it executes step S52, the control unit 39 changes the flag value to zero (step S53). If the control unit 39 determines not to switch OFF the semiconductor switch 20 (NO in S51), or after the control unit 39 executes step S53, the control unit 39 ends the power supply stop processing.

As mentioned above, in the power supply stop processing, if the flag vale is 1, that is, if the semiconductor switch 20 is ON, the control unit 39 waits until the input unit 32 receives a stop instruction. As previously mentioned, if the input unit 32 receives a stop instruction, the control unit 39 determines to switch OFF the semiconductor switch 20, and the driving circuit 22 switches OFF the semiconductor switch 20.

Note, that if the flag value is zero, and the input unit 32 receives a stop instruction, the control unit 39 executes no processing, and the driving circuit 22 keeps the semiconductor switch 20 OFF.

FIG. 6 is a timing chart showing an operation of the power supply control apparatus 12. FIG. 6 shows the graphs of the input voltage value, that is, the drain voltage of the semiconductor switch 20, and ON and OFF of the semiconductor switch 20. In these graphs, the horizontal axes show time. In FIG. 6, Vr is the reference voltage value.

As mentioned above, if the flag value is zero, that is, if the semiconductor switch 20 is OFF, and the input unit 32 receives an operation instruction, the control unit 39 determines to switch ON the semiconductor switch 20. As shown in FIG. 6, if the input unit 32 receives an operation instruction, and the input voltage value is larger than or equal to the reference voltage value Vr, the driving circuit 22 does not switch ON the semiconductor switch 20, but keeps the semiconductor switch 20 OFF. If the input unit 32 receives an operation instruction, and the input voltage value is lower than the reference voltage value Vr, the driving circuit 22 switches ON the semiconductor switch 20.

If the semiconductor switch 20 is OFF, no current flows via the semiconductor switch 20. Accordingly, if the semiconductor switch 20 is OFF, even if both ends of the load 13 are short-circuited, this short-circuit is not detected. Let us assume that the semiconductor switch 20 is switched from OFF to ON in a state where an overvoltage is generated and the load 13 is short-circuited. In this case, an extremely large current flows via the semiconductor switch 20.

If an extremely large current flows via the semiconductor switch 20, the temperatures of the lead wires that are connected to the drain and source of the semiconductor switch 20 and the lead wire between the output circuit 21 and the load 13 rapidly increase, and there is a possibility that the functions of the lead wires greatly deteriorate. Also, because a large amount of heat is generated in the ON resistance of the semiconductor switch 20, there is a possibility that the temperature of the semiconductor switch 20 rapidly rises and the function of the semiconductor switch 20 is largely degraded. Furthermore, if the semiconductor switch 20 switches from ON to OFF in a state where the extremely large current flows via the semiconductor switch 20, the switching loss is extremely large. Also when the switching loss is extremely large, the temperature of the semiconductor switch 20 rapidly rises, and there is possibility that the function of the semiconductor switch 20 is largely degraded.

However, as mentioned above, in the power supply control apparatus 12, if the input unit 32 receives an operation instruction, and the input voltage value is lower than the reference voltage value Vr, the driving circuit 22 switches ON the semiconductor switch 20. In the same case, if the input voltage value is larger than or equal to the reference voltage value Vr, the driving circuit keeps the semiconductor switch 20 OFF. For this reason, an extremely large current is prevented from flowing via the semiconductor switch 20.

Also, if the flag value is 1, that is, if the semiconductor switch 20 is ON, and the time period for which the input voltage value is larger than or equal to the reference voltage value Vr is shorter than the first reference time period, the driving circuit 22 keeps the semiconductor switch 20 ON. Accordingly, if the input voltage value is temporarily larger than or equal to the reference voltage value Vr due to, for example, external disturbance noise in the state where the semiconductor switch 20 is ON, the semiconductor switch 20 is not switched OFF, and is kept ON.

As mentioned above, if the state of the power supply system 1 is in a load dump state, the time period, for which the state in which the input voltage value is larger than or equal to the reference voltage value has been continued, is several hundred ms, for example, and is long. If the time period for which the input voltage value is larger than or equal to the reference voltage value Vr is longer than or equal to the first reference time period, that is, if the state in which the input voltage value is large has continued for a long time period, the driving circuit 22 switches OFF the semiconductor switch 20. For this reason, no overvoltage is output via the semiconductor switch 20 for a long time period. Furthermore, as mentioned above, because the driving circuit 22 switches ON the semiconductor switch 20 in a state where no overvoltage is generated, there is no possibility that an extremely large current flows via the semiconductor switch 20 for the first reference time period.

Note, that as mentioned above, if the semiconductor switch 20 is ON, and the input unit 32 receives a stop instruction, the control unit 39 determines to switch OFF the semiconductor switch 20, and the driving circuit 22 switches OFF the semiconductor switch 20. This operation is not shown in FIG. 6.

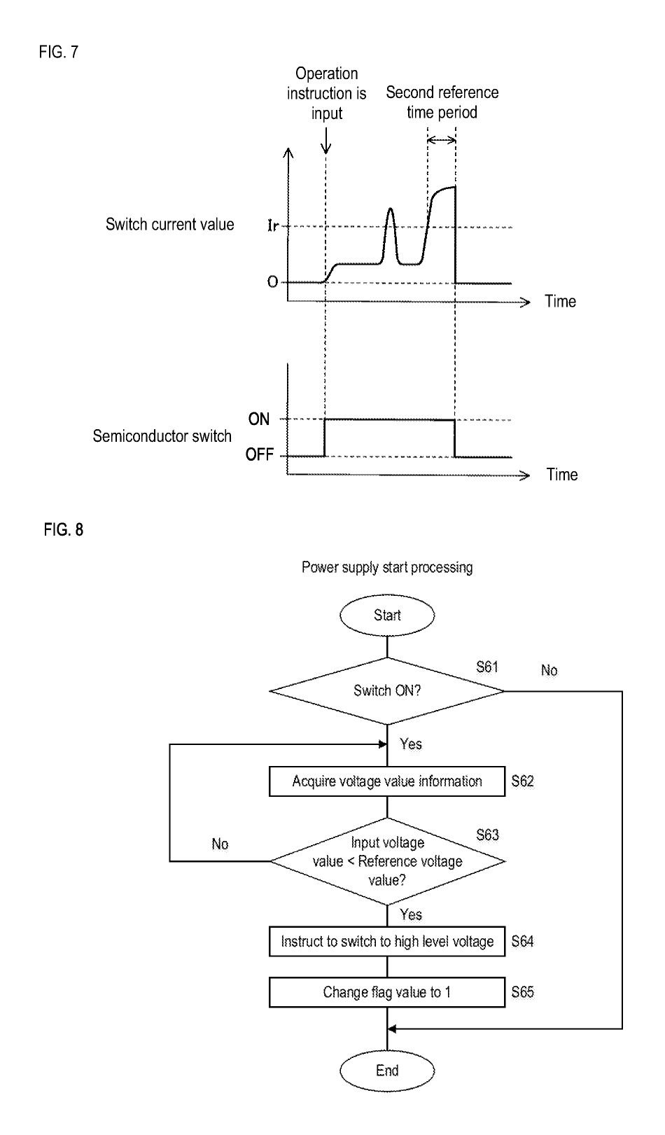

FIG. 7 is a timing chart showing another operation of the power supply control apparatus 12. FIG. 7 shows the graph of the switch current value, that is, the current value of a current flowing via the semiconductor switch 20, and the graph of ON and OFF of the semiconductor switch 20. In these graphs, the horizontal axes show time. In FIG. 7, Ir is the reference current value.

As mentioned above, if the semiconductor switch 20 is OFF, when the input unit 32 receives an operation instruction, the control unit 39 determines to switch ON the semiconductor switch 20. If the control unit 39 determines to switch ON the semiconductor switch 20, when the input voltage value is lower than the reference voltage value Vr, the driving circuit 22 switches ON the semiconductor switch 20. Accordingly, a current flows via the semiconductor switch 20, and the switch current value increases.

If the flag value is 1, that is, if the semiconductor switch 20 is ON, and the time period for which the switch current value is larger than or equal to the reference current value Ir is shorter than the second reference time period, the driving circuit 22 keeps the semiconductor switch 20 ON. Accordingly, if the switch current value is temporarily larger than or equal to the reference current value Ir due to, for example, external disturbance noise in the state where the semiconductor switch 20 is ON, the semiconductor switch 20 is not switched OFF, and is kept ON.

Also, for example, if the time period for which the switch current value is larger than or equal to the reference current value Ir is longer than or equal to the second reference time period by both ends of the load 13 being short-circuited, that is, if a large current flows via the semiconductor switch 20 for a long time period, the driving circuit 22 switches OFF the semiconductor switch 20. For this reason, no overcurrent flows via the semiconductor switch 20 for a long time period. Furthermore, as mentioned above, the semiconductor switch 20 is switched ON in a state where no overvoltage is generated, and thus there is no possibility that an extremely large current flows via the semiconductor switch 20 for the second reference time period.

### Second Embodiment

In the first embodiment, if the input unit 32 receives an operation signal in the state where the input voltage value, that is, the drain voltage of the semiconductor switch 20 is lower than the reference voltage value, the driving circuit 22 switches the semiconductor switch 20 from OFF to ON. However, the timing at which the semiconductor switch 20 is switched from OFF to ON is not limited to the timing at which the input unit 32 receives an operation signal in a state where the input voltage value is lower than the reference voltage value.

In the following description, a second embodiment will be described regarding differences from the first embodiment. Since the constituent elements other than those described below are the same as the constituent elements in the first embodiment, the same constituent portions as those in the first embodiment are assigned the same reference signs as those in the first embodiment and their description is omitted.

When the second embodiment is compared with the first embodiment, the power supply start processing and the overvoltage prevention processing that the control unit 39 executes are different.

FIG. 8 is a flowchart showing a procedure of power supply start processing in a second embodiment. Same as in the first embodiment, if the flag value is zero, that is, if the semiconductor switch 20 is OFF, the control unit 39 periodically executes the power supply start processing. Steps S61, S62, S64, and S65 of the power supply start processing in the second embodiment are the same as steps S1, S2, S4 and S5 of the power supply start processing in the first embodiment. Accordingly, detailed descriptions of steps S61, S62, S64 and S65 are omitted.

Same as in the first embodiment, after it executes step S62, the control unit 39 determines whether the input voltage value of the voltage value information acquired in step S62 is lower than the reference voltage value (step S63). If the control unit 39 determines that the input voltage value is larger than or equal to the reference voltage value (NO in S63), the control unit 39 executes step S62 and waits until the input voltage value is lower than the reference voltage value. If the control unit 39 determines that the input voltage value is lower than the reference voltage value (YES in S63), the control unit 39 executes step S64.

As mentioned above, in the power supply control processing of the second embodiment, if the input unit 32 receives an operation instruction, when the input voltage value is larger than or equal to the reference voltage value, the control unit 39 waits until the input voltage value is lower than the reference voltage value. If the input voltage value is lower than the reference voltage value, the control unit 39 instructs the output unit 33 to switch to a high level voltage. In this manner, the output unit 33 switches the voltage that is output to the driving circuit 22 to a high level voltage, and the driving circuit 22 switches ON the semiconductor switch 20.

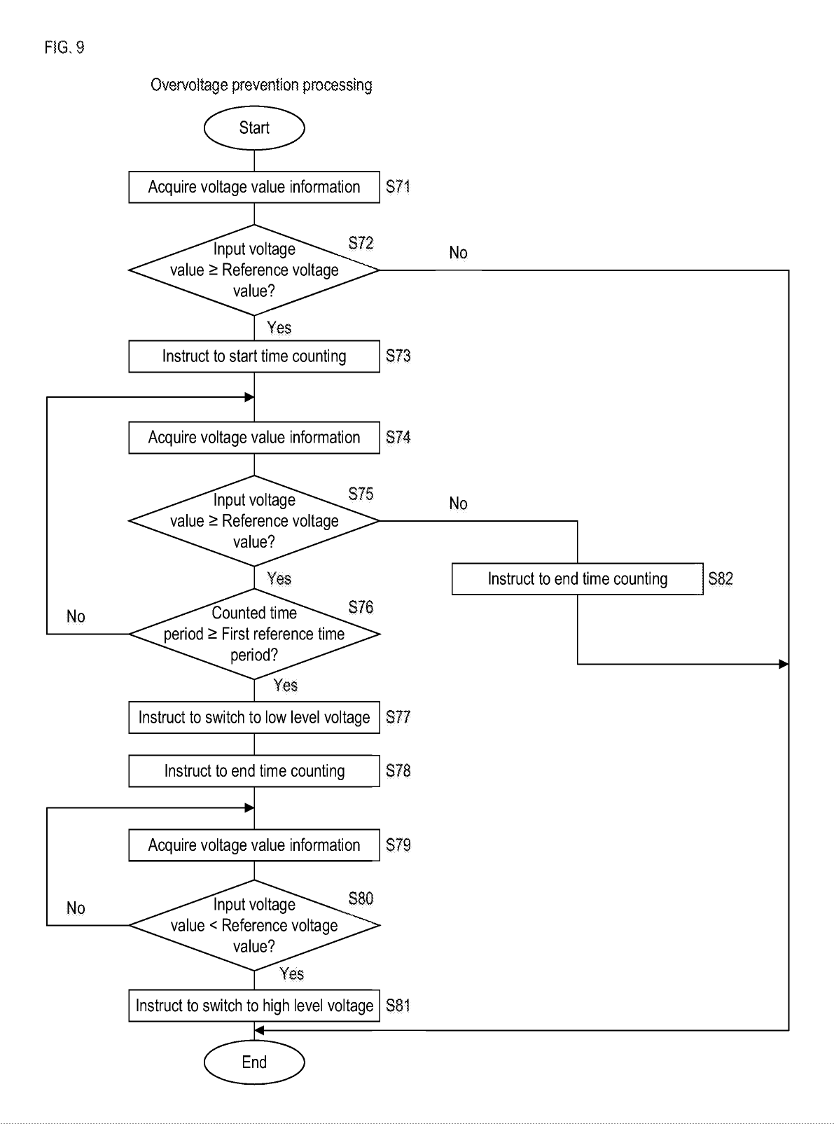

FIG. 9 is a flowchart showing a procedure of the overvoltage prevention processing. Same as in the first embodiment, if the flag value is 1, that is, if the semiconductor switch 20 is ON, the control unit 39 periodically executes the overvoltage prevention processing. Steps S71 to S74, S76, and S77 of the overvoltage prevention processing in the second embodiment are the same as steps S11 to S14, S16, and S17 of the overvoltage prevention processing in the first embodiment. Accordingly, detailed descriptions of steps S71 to S74, S76, and S77 are omitted.

Same as in the first embodiment, after it executes step S74, the control unit 39 determines whether the input voltage value of the voltage value information acquired in step S74 is larger than or equal to the reference voltage value (step S75). If the control unit 39 determines that the input voltage value is larger than or equal to the reference voltage value (YES in S75), the control unit 39 executes step S76. If the control unit 39 determines that the counted time period is shorter than the first reference time period (NO in S76), the control unit 39 executes step S74, and waits until the input voltage value is lower than the reference voltage value, or until the counted time period is longer than or equal to the first reference time period.

If the control unit 39 determines that the counted time period is longer than or equal to the first reference time period (YES in S76), the control unit 39 executes steps S77 and S78. In step S77, the control unit 39 instructs the output unit 33 to switch to a low level voltage. In this manner, the driving circuit 22 switches the semiconductor switch 20 from ON to OFF.

After it executes step S78, the control unit 39 acquires voltage value information from the A/D converter 34 (step S79), and determines whether the input voltage value of the acquired voltage value information is lower than the reference voltage value (step S80). If the control unit 39 determines that the input voltage value is larger than or equal to the reference voltage value (NO in S80), the control unit 39 executes step S79 and waits until the input voltage value is lower than the reference voltage value.

If the control unit 39 determines that the input voltage value is lower than the reference voltage value (YES in S80), the control unit 39 instructs the output unit 33 to switch to a high level voltage (step S81). In this manner, the driving circuit 22 returns the semiconductor switch 20 from OFF to ON. After it executes step S81, the control unit 39 ends the overvoltage prevention processing.

If the control unit 39 determines that the input voltage value is lower than the reference voltage value (NO in S75), the control unit 39 instructs the first timer 36 to end time counting (step S82). In this manner, the first timer 36 stops counting time. After it executes step S82, the control unit 39 ends the overvoltage prevention processing.

As mentioned above, if the flag value is 1, that is, if the semiconductor switch 20 is ON, and a state in which the input voltage value is larger than or equal to the reference voltage value has continued for the first reference time period, the driving circuit 22 switches OFF the semiconductor switch 20, and waits until the input voltage value is lower than the reference voltage value. If the input voltage value is lower than the reference voltage value, the driving circuit 22 returns the semiconductor switch 20 from OFF to ON.

Note, that if the control unit 39 instructs the output unit 33 to switch to a low level voltage in the overcurrent prevention processing or the power supply stop processing while the overvoltage prevention processing is being executed, the control unit 39 forcibly ends the overvoltage prevention processing. If the first timer is performing time counting, the control unit 39 ends the overvoltage prevention processing after the control unit 39 instructs the first timer 36 to end time counting.

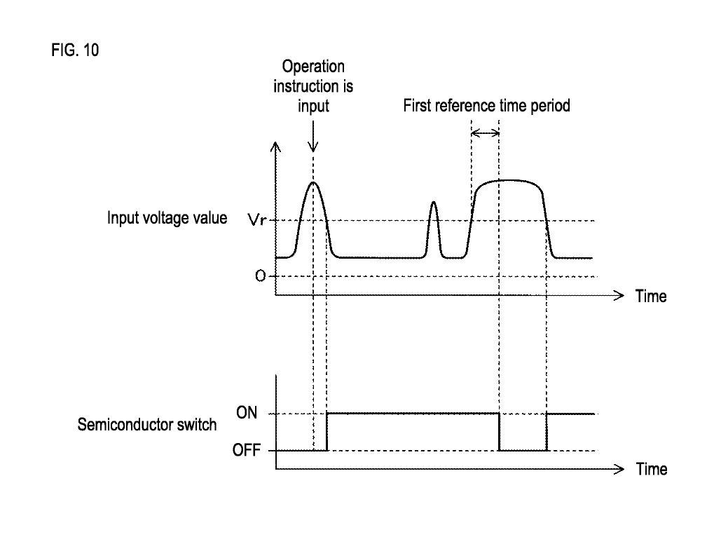

FIG. 10 is a timing chart showing an operation of the power supply control apparatus 12. FIG. 10 corresponds to FIG. 6. FIG. 10 shows the graphs of the input voltage value, that is, the drain voltage of the semiconductor switch 20, and ON and OFF of the semiconductor switch 20. In these graphs, the horizontal axes show time. Also in FIG. 10, Vr is the reference voltage value.

In the second embodiment, if the input unit 32 receives an operation instruction, when the input voltage value is larger than or equal to the reference voltage value Vr, the driving circuit 22 does not switch ON the semiconductor switch 20, keeps the semiconductor switch 20 OFF, and waits until the input voltage value is lower than the reference voltage value Vr. If the input voltage value is lower than the reference voltage value Vr, the driving circuit 22 switches ON the semiconductor switch 20.

Also, same as in the first embodiment, if the flag value is 1, that is, if the semiconductor switch 20 is ON, and the time period for which the input voltage value is larger than or equal to the reference voltage value Vr is shorter than the first reference time period, the driving circuit 22 keeps the semiconductor switch 20 ON. Furthermore, if the flag value is 1, when the time period for which the input voltage value is larger than or equal to the reference voltage value Vr is longer than or equal to the first reference time period, the driving circuit 22 switches OFF the semiconductor switch 20, and waits until the input voltage value is lower than the reference voltage value. If the input voltage value is lower than the reference voltage value, the driving circuit 22 returns the semiconductor switch 20 to ON.

Comparing the power supply control apparatus 12 of the second embodiment with the power supply control apparatus 12 of the first embodiment, in the power supply control apparatus 12 of the second embodiment, only the configuration is added in which the semiconductor switch 20 is switched ON if the input voltage value is lower than the reference voltage value Vr. Therefore, the power supply control apparatus 12 in the second embodiment similarly performs the effect of the power supply control apparatus 12 in the first embodiment.

Note, that in the first and second embodiments, hardware may also realize the configuration in which the control unit 39 switches ON the semiconductor switch 20, if the control unit 39 determines to switch ON the semiconductor switch 20, and the input voltage value is lower than the reference voltage value, and the control unit 39 keeps the semiconductor switch 20 OFF, if the input voltage value is larger than or equal to the reference voltage value.

Then, hardware may also realize the configuration in which the control unit 39 switches OFF the semiconductor switch 20, if the semiconductor switch 20 is ON, and the state in which the input voltage value is larger than or equal to the reference voltage value has continued for the first reference time period. Furthermore, hardware may also realize the configuration in which the control unit 39 switches OFF the semiconductor switch 20, if the semiconductor switch 20 is ON, and the state in which the switch current value is larger than or equal to the reference current value has continued for the second reference time period.

Realizing the above-mentioned configuration with hardware means realizing this configuration using a comparator, an AND circuit, an OR circuit, a filter circuit, or the like.

The output unit 33 switches, for example, the output voltage to a high level voltage if the control unit 39 determines to switch ON the semiconductor switch 20, and switches the output voltage to a low level voltage if the control unit 39 determines to switch OFF the semiconductor switch 20. Then, a comparison between the input voltage value and the reference voltage value and a comparison between the switch current value and the reference current value are realized by two comparators. An output circuit, which outputs a high level voltage or a low level voltage to the driving circuit 22 depending on voltages output from the output unit 33 and the two comparators, is realized by an AND circuit, an OR circuit, a filter circuit, or the like.

Also, the driving circuit 22 may also switch OFF the semiconductor switch 20 in the case where the input voltage value is larger than or equal to the reference voltage value, not in the case where the state in which the input voltage value is larger than or equal to the reference voltage value has continued for the first reference time period. Similarly, the driving circuit 22 may also switch OFF the semiconductor switch 20 in the case where the switch current value is larger than or equal to the reference current value, not in the case where the state in which the switch current value is larger than or equal to the reference current value has continued for the second reference time period.

Furthermore, the control unit 39 may not determine whether to switch ON the semiconductor switch 20, based on whether the input unit 32 receives an operation instruction. The control unit 39 may also determine, for example, to switch ON the semiconductor switch 20 based on the detection result from a not-shown sensor.

Similarly, the control unit 39 may not determine whether to switch OFF the semiconductor switch 20, based on whether the input unit 32 receives a stop instruction. The control unit 39 may also determine, for example, to switch OFF the semiconductor switch 20 based on the detection result of the not-shown sensor.

Also, the semiconductor switch 20 is not limited to an N-channel transistor, and may also be a P-channel transistor, a bipolar transistor, or the like. In this case, the input voltage value is a voltage value at the one end of the semiconductor switch 20 on the generator 10 side. Furthermore, a switch, which is arranged in the current path from the one end of the generator 10, or the positive electrode of the battery 11 to the load 13, is not limited to a semiconductor switch, and may also be a relay contact, for example. In this case, the input voltage value is a voltage value at the one end of the switch on the generator 10 side.

The first and second embodiments that were disclosed are to be considered exemplary in all respects and in no way limiting. The scope of the present disclosure is defined by the scope of the appended claims and not by the above description, and all changes that fall within the same essential spirit as the scope of the claims are included therein.

What is claimed is:

1. A power supply control apparatus for controlling power supply via a switch, the apparatus comprising:
a determination unit configured to determine whether to switch ON the switch; and
a switching unit configured to switch ON the switch, if the determination unit determines to switch ON the switch, and a voltage value at a current input terminal of the switch, to which a current is input, is lower than a predetermined voltage value.

2. The power supply control apparatus according to claim 1, wherein
the switching unit switches OFF the switch, if the switch is ON, and a state in which the voltage value at the current input terminal is larger than or equal to a second predetermined voltage value has continued for a predetermined time period.

3. The power supply control apparatus according to claim 1, wherein the switching unit switches OFF the switch, if the switch is ON, and a state in which a current value of a current that flows via the switch is larger than or equal to a predetermined current value has continued for a second predetermined time period.

4. A power supply control method for controlling power supply via a switch, the method comprising:
a step of determining whether to switch ON the switch; and
a step of switching ON the switch, if it is determined to switch ON the switch, and a voltage value at a current input terminal of the switch, to which a current is input, is lower than a predetermined voltage value.

5. A computer program for causing a computer to execute:
a step of determining whether to switch ON a switch;
a step of determining whether a voltage value at a current input terminal of the switch, to which a current is input, is lower than a predetermined voltage value, if it is determined to switch ON the switch; and
a step of instructing to switch ON the switch, if it is determined that the voltage value at the current input terminal is lower than the predetermined voltage value.

6. The power supply control apparatus according to claim 2, wherein the switching unit switches OFF the switch, if the switch is ON, and a state in which a current value of a current that flows via the switch is larger than or equal to a predetermined current value has continued for a second predetermined time period.
